(19) United States
(12) Patent Application Publication
(10) Pub. No.: US 2024/0200285 A1
(43) Pub. Date: Jun. 20, 2024

(54) GROUND PROCESSING ROLLER FOR A GROUND PROCESSING MACHINE

(71) Applicant: Hamm AG, Tirschenreuth (DE)

(72) Inventors: Stefan BÄUML, Tirschenreuth (DE); Marina STRIEGL, Altenstadt (DE)

(21) Appl. No.: 18/538,319

(22) Filed: Dec. 13, 2023

(30) Foreign Application Priority Data
Dec. 19, 2022 (DE) 10 2022 133 783.9

(51) Int. Cl. E01C 19/28; H02K 7/00; H02K 7/116

(52) U.S. Cl. CPC E01C 19/286; H02K 7/003; H02K 7/116

(57) ABSTRACT

A ground processing roller for a ground processing machine, in particular a ground compactor, includes a roller shell extending in the direction of a roller rotation axis and surrounding the roller rotation axis and a roller drive for driving the roller shell to rotate about the roller rotation axis. The roller drive includes an electric roller drive motor and a gear arrangement. A motor drive element of the electric roller drive motor is coupled to a gear input element of the gear arrangement by a speed conversion arrangement for torque transmission.

The present invention relates to a ground processing roller for a ground processing machine, in particular a ground compactor, comprising a roller shell extending in the direction of a roller rotation axis and surrounding the roller rotation axis and a roller drive for driving the roller shell to rotate about the roller rotation axis.

In the case of ground processing machines designed, for example, as ground compactors, it is known to drive one or possibly more ground processing rollers provided on the ground processing machine to rotate about a respective roller rotation axis in order to move such a ground processing machine over the ground to be processed. A roller drive used for this purpose can comprise a hydraulic circuit with a hydraulic pump driven, for example, by an internal combustion engine and a hydraulic motor coupled to the roller shell of such a ground processing roller.

In order to avoid the use of fossil fuels, there is a tendency to use electric roller drive motors in such roller drives. In order to move a ground processing machine over the ground to be moved at the desired speed, such an electric roller drive motor must generally be coupled to a gear arrangement in order to convert, in particular reduce, the speed of the electric roller drive motor to a speed of the ground processing roller that is suitable for the movement of the ground processing machine.

It is the object of the present invention to provide a ground processing roller in which a suitable speed of a roller shell of the ground processing roller, which is driven to rotate by an electric roller drive motor, can be achieved with structurally simple measures. According to the present invention, this object is achieved by a ground processing roller for a ground processing machine, in particular a ground compactor, comprising a roller shell extending in the direction of a roller rotation axis and surrounding the roller rotation axis and a roller drive for driving the roller shell to rotate about the roller rotation axis, wherein the ground processing roller is characterized in that the roller drive comprises an electric roller drive motor and a gear arrangement, and that a motor drive element of the electric roller drive motor is coupled to a gear input element of the gear arrangement by means of a speed conversion arrangement for torque transmission.

By providing the speed conversion arrangement between the electric roller drive motor and the gear arrangement, on the one hand, the possibility is created of positioning the electric roller drive motor spatially decoupled from the gear arrangement. On the other hand, the speed conversion arrangement provides the possibility of speed conversion before the gear arrangement, so that the gear arrangement itself can be designed with a simpler structure, while nevertheless achieving, by interaction of the speed conversion arrangement with the gear arrangement, the speed of a ground processing roller or of a roll shell thereof required for moving the ground processing machine.

In order to be able to use a simple structure in the region of the speed conversion arrangement, it is proposed that the gear input element can be driven by the electric roller drive motor to rotate about the roller rotation axis, and that the motor drive element can rotate about a motor rotation axis, which is eccentric to the roller rotation axis and essentially parallel thereto.

For a compact design of the ground processing roller, the electric roller drive motor, the gear arrangement and the speed conversion arrangement can be arranged in a roller interior surrounded by the roller shell.

Since an electric roller drive motor generally has a high level of efficiency in a speed range that is above the speed range that can be achieved for a ground processing roller, it is proposed that the speed conversion arrangement is designed for speed reduction.

The motor drive element may include a drive wheel of the speed converting arrangement connected to a motor shaft of the electric roller drive motor for common rotation, and the gear input element may include an output gear of the speed connected to a gear input shaft of the gear arrangement for common rotation and coupled to the drive wheel for torque transmission—Conversion arrangement include.

In a design that is easy to set up and can be operated reliably, it can be provided that the drive wheel is designed as a drive pulley, that the driven wheel is designed as a driven pulley, and that the drive pulley and the driven pulley are coupled by at least one belt, preferably a toothed belt, for torque transmission.

In an alternative embodiment, particularly when very large drive torques have to be transmitted in larger ground processing machines, the drive wheel can be designed as a drive gear and the driven gear can be designed as an driven gear, and the drive gear and the driven gear can:
be coupled to one another by a chain for torque transmission,
   or
be coupled to one another by at least one intermediate gear for torque transmission,
   or
are in meshing engagement with each other.

The gear arrangement can be designed as a planetary gear, which can comprise at least two planetary gear stages that are effective in series for torque transmission in order to achieve the required speed conversion, in particular reduction.

In order to be able to transmit the torque introduced into the gear arrangement to the roller shell, a gear output element of the gear arrangement can be connected to the roller shell for common rotation about the roller rotation axis.

According to a further aspect of the invention, which can preferably be combined with the preceding design aspects, a vibration generation system with an electric unbalance drive motor and an unbalance shaft which can be driven by the electric unbalance drive motor for rotation about an unbalance shaft rotation axis can be provided in a ground processing roller, the electric unbalance drive motor being connected to the unbalance shaft by means of at least one cardan joint for common rotation.

By means of such a vibration generation system, depending on the design of the vibration generation system, a vibration movement can be generated on a ground processing roller, i.e. a deflection essentially orthogonal to the roller rotation axis can be generated, or an oscillatory movement can be generated, i.e. a periodic back and forth rotational movement of the roller shell can be generated, which is superimposed on the rolling movement. By providing the at least one cardan joint between the unbalance shaft and the electric unbalanced drive motor, the electric unbalanced drive motor is essentially decoupled from vibratory movements caused on the ground processing roller or on the roller shell, so that impairment of the operation of the electric unbalanced drive motor is avoided.

To achieve efficient radial motion decoupling, a motor shaft of the electric unbalance drive motor can be coupled to a cardan shaft by means of a cardan joint, and the cardan shaft can be coupled to the unbalance shaft by means of a further cardan joint.

The unbalance shaft can be rotatably supported about the unbalance shaft rotation axis on a roller support structure that is rotatably connected to the roll shell about the roller rotation axis, and the electric unbalance drive motor can be supported on a machine support structure that rotatably supports the roller shell about the roller rotation axis, namely a system region that basically does not rotate during operation.

In order to generate an oscillatory movement or an oscillatory torque which acts on the roller shell to carry out an oscillatory movement and is essentially tangentially oriented to the roller rotation axis, at least two unbalanced masses which can be rotated about a respective unbalanced rotation axis which is eccentric to the unbalance shaft rotation axis and which are substantially parallel to the rotation axis of the roller can be driven for rotation by means of the unbalance shaft. Alternatively or additionally, in order to generate a vibration movement or a vibration force acting on the roller shell to carry out a vibration movement and oriented essentially orthogonally to the roller rotation axis, an unbalance mass which can be rotated with the unbalance shaft about the unbalance shaft rotation axis can be supported on the unbalance shaft.

The unbalance shaft rotation axis is advantageously essentially coaxial with the roller rotation axis.

The invention furthermore relates to a ground processing machine, in particular a ground compactor, comprising at least one ground processing roller constructed according to the invention.

The invention is described in detail below with reference to the attached figures. In particular:

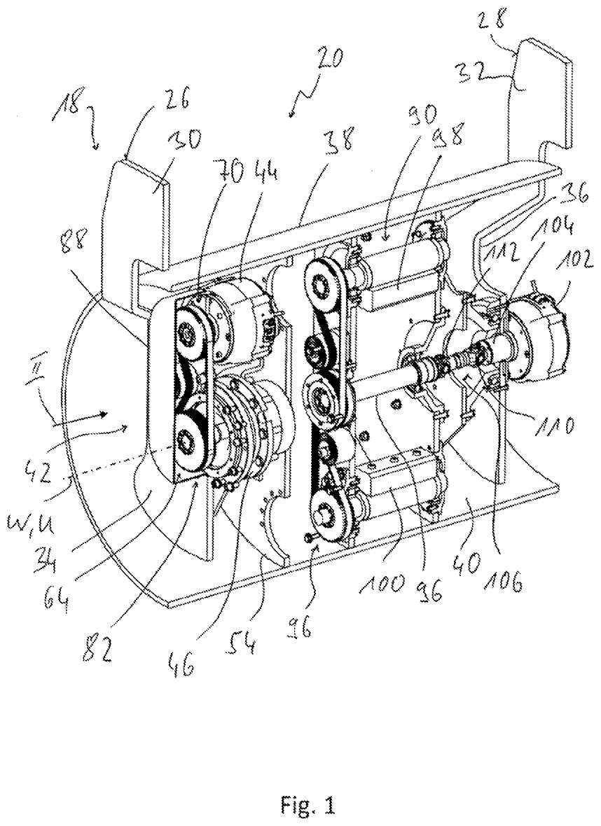

FIG. 1 is a perspective longitudinal sectional view of a ground processing roller;

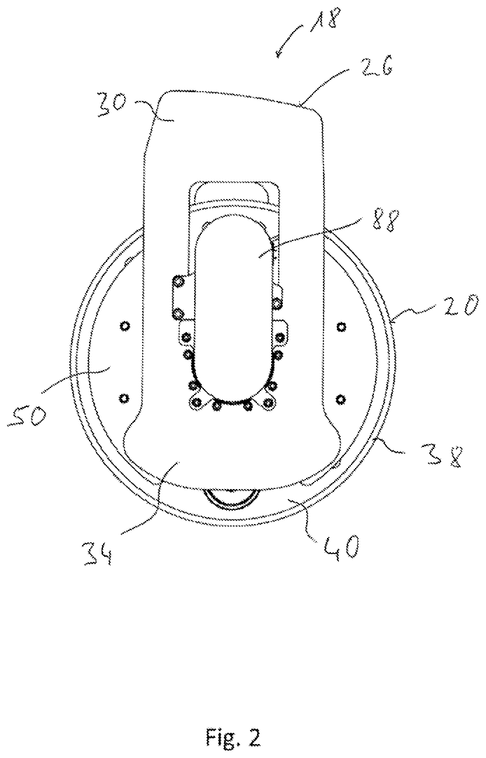

FIG. 2 is a side view of the ground processing roller of FIG. 1 in viewing direction Il in FIG. 1;

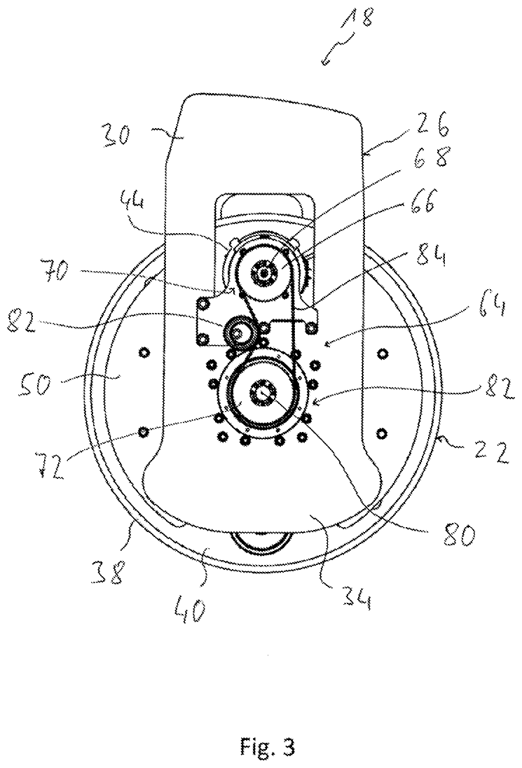

FIG. 3 is a view corresponding to FIG. 2 with the cover housing of a speed conversion arrangement removed;

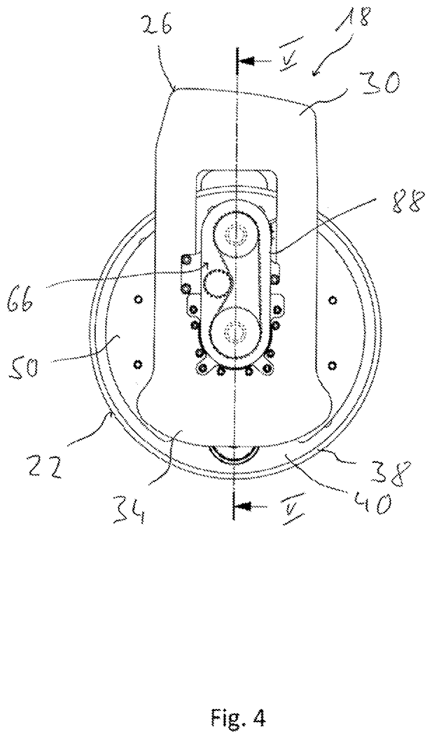

FIG. 4 is a view corresponding to FIG. 2 with the cover housing of the speed conversion arrangement shown transparently;

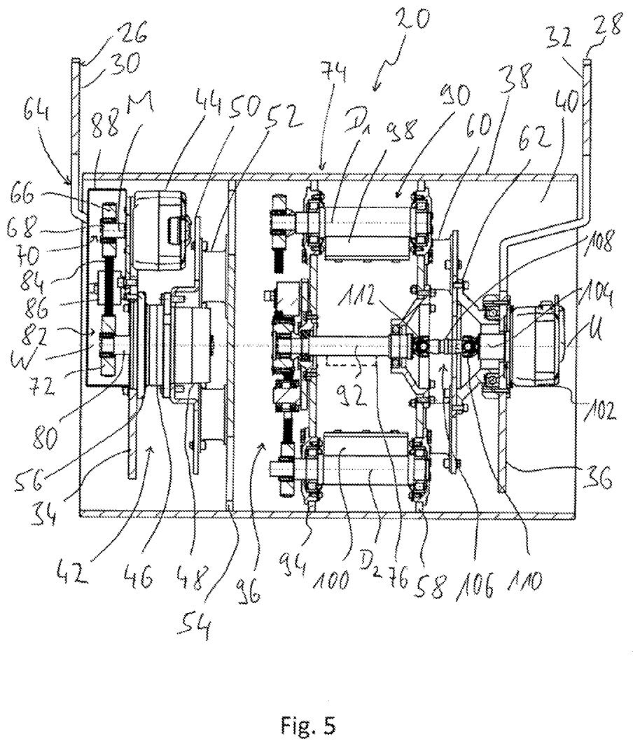

FIG. 5 is a longitudinal sectional view of the ground processing roller along line V-V in FIG. 4;

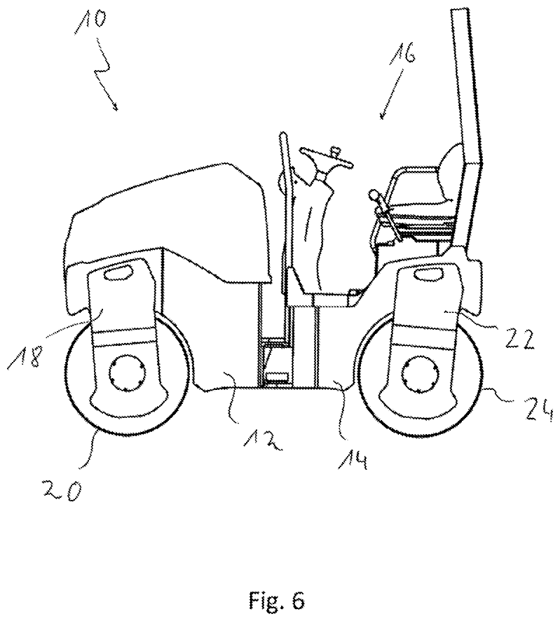

FIG. 6 is a side view of a ground processing machine with two ground processing rollers.

Before the structure of a ground processing roller is described in detail below with reference to FIGS. 1 to 5, a ground processing machine 10 designed as a ground compactor is described with reference to FIG. 6, on which, for example, such a ground processing roller can be used.

The ground processing machine 10 comprises a front machine frame 12 and a rear machine frame 14 which is articulated to the front machine frame 12 for steering the ground processing machine 10. On the rear machine frame 14, an operator station 16 is provided for an operator operating the ground processing machine 10.

On the front machine frame 12, by means of a machine support structure generally designated 18, a ground processing roller 20, which acts as a compactor roller in the example shown, is rotatably supported about a roller rotation axis that is orthogonal to the plane of the drawing in FIG. 6. Likewise, a ground processing roller 24, which also acts as a compactor roller, is rotatably supported on the rear machine frame 14 by means of a machine support structure 22 about a roller rotation axis which is orthogonal to the plane of the drawing in FIG. 6.

In FIGS. 1 to 5, the structure of the ground processing roller 20 and the machine support structure 18 assigned to it will be described below as an example. It should be noted that the ground processing roller 24 can be constructed with the machine support structure 22 in basically the same way.

In particular in FIGS. 1 and 5 it can be seen that the machine support structure 18 of the ground processing roller 20 comprises two plate-like support elements 26, 28. These can be fixed to the front machine frame 12 with a respective upper portion 30, 32. With lower portions 34, 36 offset towards one another with respect to the respective upper portion 30, 32 in the direction of the roller rotation axis W, the support elements 26, 28 lie in a roller interior 40 of the ground processing roller 20 surrounded by a roller shell 38. In these portions 34, 36, as explained in detail below, the two support elements 26, 28 carry the roller shell 38 and various system regions of the ground processing roller 20 arranged in the roller interior 40.

It should be noted that, for example, in the case of a stool-steered ground processing machine, the two support elements 26, 28 could be fixed to a steering stool or could form a part of such a steering stool, which in the case of the ground processing roller 20 can be supported in a steerable, namely pivotable manner in a front region of a machine frame, which for example, also carries the ground processing roller 24.

The ground processing roller 20 includes a roller drive generally designated 42. The roller drive 42 comprises an electric roller drive motor 44 and a gear arrangement 46. A coupling disk 50 is carried on a gear output element 48 of the gear arrangement 46, which is designed, for example, in the form of a housing, and which is fixed to an inner side of the roller shell 40, for example by welding, which supports, via a plurality of elastic coupling elements 52, a connected support disk 54, also generally referred to as a round plate, or is connected thereto, for common rotation about the roller rotation axis W. The gear output element 48, the coupling disk 50 and the support disk 54 are thus connected for common rotation about the roller rotation axis W.

A non-rotating housing region 56 of the gear arrangement 46 is carried on the portion 34 of the support element 26, which is offset in the roller interior 40, so that in the region shown on the left in FIG. 1 and in FIG. 5, the ground processing roller 20 or its roller shell 38 is rotatably supported via the gear arrangement 46 on the support element 26 of the machine support structure 18 so as to be rotatable about the roller rotation axis W. At its other axial end region, the ground processing roller 20 or the roller shell 38 of the same is rotatably supported about the roller rotation axis W via a further support disk 58 fixed to the inside of the roller shell 38, a plurality of elastic coupling elements 60 and a coupling assembly 62 which is connected to these and is constructed in several parts in the exemplary embodiment shown, on the portion 36 of the support element 28 of the machine support structure 18, which is arranged with an offset on the roller interior 40. The roller drive 42 comprises a speed conversion arrangement 64 designed to reduce the speed for torque transmission between the electric roller drive motor 44 and the gear arrangement 46. The speed conversion arrangement 64 comprises a drive wheel 66, which in the illustrated embodiment is designed as a drive pulley, which together with a motor shaft 68 of the electric roller drive motor 44 provides a motor drive element 70. The speed conversion arrangement 66 further comprises an output wheel 72 designed as an output pulley, which together with a gear input shaft 80 of the gear arrangement 46 forms a gear input element 82.

For torque transmission between the motor drive element 70 and the gear input element 82, a belt 84, preferably designed as a toothed belt, is provided in the exemplary embodiment shown. In order to keep this under tension, a tension roller 86 can be provided.

In particular, in FIGS. 1 and 5 it can be seen that the entire roller drive 42, i.e. the electric roller drive motor 44, the gear arrangement 46 and the speed conversion arrangement 64, is arranged in the roller interior 40 surrounded by the roller shell 38, so that no system regions of the roller drive 42 protrude axially beyond the roller shell 38. A lid-like cover housing 88, which axially covers the speed conversion arrangement 64 and is fixed, for example, on the support element 26, is also positioned completely in the roller interior 40 in this arrangement.

It can also be seen that in the case of the ground processing roller 20, the electric roller drive motor 44 lies laterally next to the gear arrangement 46 with respect to the roller rotation axis W, i.e. it essentially completely axially overlaps with it and, for example, just like the housing region 56 of the gear arrangement 46, can be fixed, for example by screwing, to the portion 34 of the support element 26. The motor drive element 70, i.e. the motor shaft 68 and the drive wheel 66 connected to it for common rotation, can be rotated about a motor rotation axis M which is essentially parallel to the roller rotation axis W and is. positioned eccentrically thereto. There is therefore a comparatively large degree of design freedom with regard to the positioning of the electric roller drive motor 44 with respect to the gear arrangement 46 both in the axial direction and in the radial direction. In particular in FIGS. 3 and 4 it can be seen that the drive wheel 66 and the driven wheel 72 have different diameters from one another. In particular, the drive wheel 66 has a smaller diameter than the driven wheel 72, so that the speed conversion arrangement 64 is effective for speed reduction and therefore the gear input element 82 rotates at a lower speed than the motor drive element 70. Therefore, in the region of torque transmission between the electric roller drive motor 44 and the gear arrangement 46 a first stage of speed reduction already takes place, so that the gear arrangement 46, which is basically also designed for speed reduction, only has to be effective for reduction to a lesser extent. For example, the gear arrangement 46 can be constructed as a two-stage planetary gear, in which the input speed, i.e. the speed of the gear input shaft 80, is successively reduced to a speed in two gear stages serially effective in the torque flow, which is suitable for operating the ground processing machine 10 in a desired speed range.

It should be noted that the speed conversion arrangement 64 could be designed in a different manner than shown. For example, the belt 84 could be designed as a conventional V-belt, or several such belts 84 could cooperate parallel to one another with one or more correspondingly designed drive wheels 66 or one or more correspondingly designed driven wheels 78. In a further alternative embodiment, the drive wheel 66 could be designed as a drive gear, and the driven wheel 78 could be designed as a driven gear. These could be in direct meshing engagement with one another or could be in meshing engagement with one or more intermediate gears for torque transmission. Such gears could also be coupled to one another via one or more chains acting parallel to one another and thus connected for torque transmission.

In a further alternative embodiment, the speed conversion arrangement 64 could be designed as an angular gear. The drive wheel 66 coupled to the motor shaft 68 and the output wheel 72 coupled to the gear input shaft 82 are each designed in the manner of a bevel gear, as is an intermediate gear that acts between them or is in meshing engagement with them, which in such a configuration can be rotated about a rotation axis which is parallel to the motor rotation axis M and to the roller rotation axis W. With each such pairing of bevel gears meshing with one another, the two axes of rotation involved are then at an angle of approximately 90° to one another.

Even when using an angular gear, the drive wheel 66 and the driven wheel 72 could be in direct meshing engagement with one another. These can also be designed as bevel gears. With such a design, there is greater freedom with regard to the positioning of the electric roller drive motor 44, in particular with regard to the orientation of its motor rotation axis M. This could, for example, be oriented orthogonally to the roller rotation axis W and thus also to the rotation axis of the gear input element 82.

The ground processing roller 20 further comprises a vibration generation system, generally designated 90. The vibration generation system 90 comprises an unbalance shaft 92, which is rotatably supported in one of its axial end regions with respect to the support disk 58 and is rotatably supported in its other axial end region with respect to a further support disk 94 and is thus basically rotatable in the roller interior 40 about an unbalance shaft rotation axis U which is concentric with the roller rotation axis W. The two support disks 58, 94 thus form a roller support structure 74 for the unbalance shaft 92. Via a belt drive system generally designated 96, the unbalance shaft 92 rotatably supports two unbalanced masses 98, 100 offset from one another at an angular distance of 180° about the roller rotation axis W or the unbalance shaft rotation axis U about respective unbalance rotation axes D1, D2 on the two support disks 58, 94. When the two unbalanced masses 98, 100 rotate about the respective unbalance axes of rotation D1, D2, they generate an oscillation torque that is essentially tangential to the roller rotation axis W, which causes the ground processing roller 20 or the roller shell 38 to periodically rotate back and forth about the roller rotation axis W.

The vibration generation system 90 further comprises an electric unbalance drive motor 102, which is supported, for example, on the portion 36 of the support element 28 of the machine support structure 18. A motor shaft 104 of the electric unbalance drive motor 102 is connected to the unbalance shaft 92 for common rotation by means of a cardan shaft generally designated 106. The cardan shaft 106 comprises a shaft portion 108, which is coupled at its two axial ends via a cardan joint 110 or 112 to the motor shaft 104 of the electric unbalance drive motor 102 on the one hand and to the unbalance shaft 92 on the other hand.

Due to the use of the cardan shaft 108, a radial decoupling of the electric unbalance drive motor 102 from the unbalance shaft 92 is achieved. Since the unbalance shaft 92 can basically carry out radial movements with respect to the electric unbalance drive motor 102 due to the presence of the elastic coupling elements 52, 60, radial forces could be transmitted to the motor shaft 104 of the electric unbalance drive motor 102 without the use of the cardan shaft 106, so that also the rotor coupled with the motor shaft 104 could be acted upon radially, which could affect the operating characteristics or the functionality of the electric unbalance drive motor 102 due to undesirable or undefined relative movements between the rotor and the stator of the same.

It should be noted that alternatively or in addition to the illustrated generation of an oscillatory torque by the vibration generation system 90, this could also be designed to generate a vibration force or a vibration movement. For this purpose, a further or an alternative unbalance mass 76, indicated by a dashed line in FIG. 5, having a center of mass which is eccentric to the unbalance shaft rotation axis U can be provided, so that in case of rotation of the unbalance shaft 92, radial forces are exerted or transmitted to the roller shell 38 and this can be set into a vibrating movement in a manner known per se.

1. A ground processing roller for a ground processing machine, in particular a ground compactor, comprising a roller shell (38) extending in the direction of a roller rotation axis (W) and surrounding the roller rotation axis (W) and a roller drive (42) for driving the roller shell (38) to rotate about the roller rotation axis (W), characterized in that the roller drive (42) comprises an electric roller drive motor (44) and a gear arrangement (46), and in that a motor drive element (70) of the electric roller drive motor (44) is coupled to a gear input element (82) of the gear arrangement (46) by means of a speed conversion arrangement (64) for torque transmission.

2. The ground processing roller of claim 1,
characterized in that the gear input element (82) can be driven by the electric roller drive motor (44) to rotate about the roller rotation axis (W), and in that the motor drive element (70) is rotatable about a motor rotation axis (A) which is eccentric to the roller rotation axis (W) and is essentially parallel.

3. The ground processing roller of claim 1 or 2,
characterized in that the electric roller drive motor (44), the gear arrangement (46) and the speed conversion arrangement (64) are arranged in a roller interior (40) surrounded by the roller shell (38).

4. The ground processing roller of any one of claims 1-3,
characterized in that the speed conversion arrangement (64) is designed for speed reduction.

5. The ground processing roller of any one of claims 1-4,
characterized in that the motor drive element (70) comprises a drive wheel (66) of the speed converting arrangement (64) connected to a motor shaft (68) of the electric roller drive motor (44) for common rotation, and in the gear input element (82) comprises an output gear (72) of the speed conversion arrangement (64) connected to a gear input shaft (80) of the gear arrangement (46) for common rotation and coupled to the drive wheel (66) for torque transmission.

6. The ground processing roller as claimed in claim 5,
characterized in that the drive wheel (66) is designed as a drive pulley, in that the driven wheel (72) is designed as a driven pulley, and in that the drive pulley and the driven pulley are coupled by at least one belt (84), preferably toothed belt, for torque transmission.

7. The ground processing roller of claim 5,
characterized in that the drive wheel (66) is designed as a drive gear, in that the driven wheel (72) is designed as a driven gear, and in that the drive gear and the driven gear:
are coupled to one another by a chain for torque transmission,
or
are coupled to one another by at least one intermediate gear for torque transmission,
or
are in meshing engagement with each other.

8. The ground processing roller of any one of claims 1-7,
characterized in that the gear arrangement (46) is designed as a planetary gear.

9. The ground processing roller of claim 8,
characterized in that the planetary gear comprises at least two planetary gear stages that are effective in series for torque transmission.

10. The ground processing roller of any one of claims 1-9,
characterized in that a gear output element (48) of the gear arrangement (46) is connected to the roller shell (38) for common rotation about the roller rotation axis (W).

11. The ground processing roller of any one of claims 1-10, or the preamble of claim 1,
characterized in that a vibration generation system (90) is provided with an electric unbalance drive motor (102) and an unbalance shaft (92) which can be driven by the electric unbalance drive motor (102) for rotation about an unbalance shaft rotation axis (U), and in that the electric unbalance drive motor (102) is connected to the unbalance shaft (92) for common rotation by means of at least one cardan joint (110, 112).

12. The ground processing roller of claim 11,
characterized in that a motor shaft (104) of the electric unbalance drive motor (102) is coupled to a cardan shaft (106) by means of a cardan joint (110) and the cardan shaft (106) is coupled to the unbalance shaft (92) by means of a further cardan joint (112).

13. The ground processing roller of claim 12,
characterized in that the unbalance shaft (92) is rotatably supported about the unbalance shaft rotation axis (U) on a roller support structure (74) which is rotatably connected to the roll shell (38) about the roll rotation axis (W), and in that the electric unbalance drive motor (102) is supported on a machine support structure (18) which rotatably supports the roller shell (38) about the roller rotation axis (W).

14. The ground processing roller of claim 11, 12 or 13,
characterized in that, by means of the unbalance shaft (92), at least two unbalanced masses (98, 100) which can be rotated about a respective unbalanced rotation axis (D₁, D₂) which is eccentric to the unbalance shaft rotation axis (U) and substantially parallel can be driven for rotation, and/or in that an unbalanced mass (76) which can be rotated with the unbalance shaft (92) about the unbalance shaft rotation axis (U) is supported on the unbalance shaft (92).

15. The ground processing roller of any one of claims 11-14,
characterized in that the unbalance shaft rotation axis (U) is essentially coaxial with the roller rotation axis (W).

16. A ground processing machine, in particular a ground compactor, comprising at least one ground processing roller (20) of any one of claims 1-15.
